(19) United States
(12) Patent Application Publication
(10) Pub. No.: US 2026/0288504 A1
(43) Pub. Date: Sep. 24, 2026

(54) SIMULATING EXISTING PCIE CARDS USING ARTIFICIAL INTELLIGENCE TO PREDICT SIGNALING BEHAVIORS IN UNTRAINED SCENARIOS

(71) Applicant: Lenovo Global Technology (United States) Inc., Morrisville, NC (US)

(72) Inventors: Zane Ali, Orangevale, CA (US); Jeffrey Brian Pitts, Durham, NC (US); Edward Sackinger, Raleigh, NC (US); Jordan Ferguson, Montgomery, TX (US); Benjamin Frisch, Orlando, FL (US)

(21) Appl. No.: 19/082,585

(22) Filed: Mar. 18, 2025

(51) Int. Cl. G06F 9/455; G06F 13/42; G06N 20/00

(52) U.S. Cl. CPC G06F 9/45508; G06F 13/4221; G06N 20/00; G06F 2213/0026

(57) ABSTRACT

An apparatus for simulating a PCIe card includes a PCIe emulation card that plugs into a PCIe interface of a test system and with a PCIe interface of the PCIe emulation card for a PCIe card. The apparatus includes a data receiver module that receives data from the PCIe emulation card during test system testing using PCIe cards plugged into the PCIe emulation card. The apparatus includes a model builder module builds an AI model based on the received data configured to emulate a PCIe card through the PCIe emulation card. The apparatus includes a simulation module uses the AI model to emulate a PCIe card through the PCIe emulation card while the PCIe emulation card is plugged into a test system and in response to testing of the test system without a PCIe card plugged into the PCIe interface of the PCIe emulation card.

### FIELD

The subject matter disclosed herein relates to signal emulation and more particularly relates to a peripheral component interconnect express (“PCIe”) emulation card using signals between the PCIe card and a system under test to build an Artificial Intelligence model for later use with the PCIe emulation card to simulate a PCIe card.

### BACKGROUND

In many test scenarios computer manufacturers and others perform tests on computing devices (“systems under test”) where the computing devices include a PCIe card. Often a new PCIe card will be issued by a manufacturer and may be distributed to the manufacturer of the computing devices under test in limited quantities and/or limited geographic locations. Thus, there are situations where a manufacturer of computing devices has a need to test many computing devices while having a very limited quantity of PCIe cards.

### BRIEF SUMMARY

An apparatus for simulating an existing PCIe card using a PCIe emulation card includes a PCIe emulation card configured to plug into a PCIe interface of a system under test and configured for a PCIe card to plug into a PCIe interface of the PCIe emulation card. The system under test includes a computing device with a processor. The apparatus includes a data receiver module configured, during a training phase, to receive data from the PCIe emulation card during testing of one or more systems under test using one or more PCIe cards plugged into the PCIe emulation card, and a model builder module configured to build an artificial intelligence (“AI”) model based on the received data. The AI model is configured to emulate a PCIe card through the PCIe emulation card. The apparatus includes a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card. All or a portion of the modules include hardware circuits, a programmable hardware device, and/or executable code stored on non-transitory computer readable storage media.

A method for simulating an existing PCIe card using a PCIe emulation card includes, during a training phase, receiving data, via a data receiver module, from a PCIe emulation card connected to a host during testing of one or more systems under test using one or more PCIe cards plugged into the PCIe emulation card. The PCIe emulation card is configured to plug into a PCIe interface of a system under test and is configured for a PCIe card to plug into a PCIe interface of the PCIe emulation card. The system under test includes a computing device with a processor. The method includes building, via a model builder module, an AI model based on the received data. The AI model is configured to emulate a PCIe card through the PCIe emulation card. The method includes, during a utilization phase, using, via a simulation module, the AI model to emulate a PCIe card through the PCIe emulation card while the PCIe emulation card is plugged into a system under test and in response to testing of the system under test without a PCIe card plugged into the PCIe interface of the PCIe emulation card.

An apparatus for simulating an existing PCIe card using a PCIe emulation card includes a PCIe emulation card configured to plug into a PCIe interface of a system under test and configured for a PCIe card to plug into a PCIe interface of the PCIe emulation card. The system under test includes a computing device with a processor. The apparatus includes a host connected to the PCIe emulation card. The host includes a data receiver module configured, during a training phase, to receive data from the PCIe emulation card during testing of a plurality of systems under test in combination with a plurality of PCIe cards plugged into the PCIe emulation card. The received data includes signals from the plurality of PCIe cards plugged into the PCIe emulation card and signals from the plurality of systems under test. The host includes a model builder module configured to build an AI model based on the received data and/or a previous AI model. The AI model is configured to emulate a PCIe card through the PCIe emulation card. The model builder module uses machine learning to build the AI model. The machine learning uses the received data and/or the previous AI model. The apparatus includes a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card. All or a portion of the modules include hardware circuits, a programmable hardware device, and/or executable code stored on non-transitory computer readable storage media.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating a system for simulating an existing peripheral component interconnect express (“PCIe”) card using a PCIe emulation card connected to an external host, according to various embodiments;

FIG. 1B is a schematic block diagram illustrating a system for simulating an existing PCIe card using a PCIe emulation card connected to an internal host, according to various embodiments;

FIG. 2A is a side view schematic block diagram illustrating the PCIe emulation card and a PCIe card for the systems of FIGS. 1A and 1B, according to various embodiments;

FIG. 2B is a side view schematic block diagram illustrating use of the PCIe emulation card of FIG. 2A where the PCIe card is detached, according to various embodiments;

FIG. 3A is a side view schematic block diagram illustrating a PCIe emulation card with external connections and a similar PCIe card with external connections for the system of FIG. 1A, according to various embodiments;

FIG. 3B is a side view schematic block diagram illustrating use of the PCIe emulation card of FIG. 3A where the PCIe card is detached, according to various embodiments;

FIG. 4 is a schematic block diagram illustrating an apparatus for simulating an existing PCIe card using a PCIe emulation card connected to the apparatus, according to various embodiments;

FIG. 5 is a schematic block diagram illustrating another apparatus for simulating an existing PCIe card using a PCIe emulation card connected to the apparatus, according to various embodiments;

FIG. 6 is a schematic flow chart diagram illustrating a method for simulating an existing PCIe card using a PCIe emulation card connected to a host, according to various embodiments;

FIG. 7 is a schematic flow chart diagram illustrating a method for building an AI model of PCIe cards using a PCIe emulation card connected to a host, according to various embodiments;

FIG. 8 is a schematic flow chart diagram illustrating a method for using the AI model of FIG. 7 using a PCIe emulation card to simulate a PCIe card, according to various embodiments;

FIG. 8 is a schematic flow chart diagram illustrating using a dataset of PCIe cards to create an AI model and the selecting a PCIe card and a test machine for the AI model to simulate and then using the AI model to simulate the selected PCIe card, according to various embodiments;

FIG. 9 is a schematic flow chart diagram illustrating building an AI model using different systems and PCIe cards and then selecting a PCIe card to emulate and entering system under test data for the AI model and executing the AI model on a PCIe emulation card to simulate the selected PCIe card, according to various embodiments; and

FIG. 10 is a schematic flow chart diagram illustrating executing an AI model along with additional test data to update the AI model and then using the AI model or an AI model from an external model provider to use the AI model executing on a PCIe emulation card to simulate a PCIe card, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for simulating an existing PCIe card using a PCIe emulation card is disclosed. A method and another apparatus also perform the functions of the apparatus. The apparatus includes a PCIe emulation card configured to plug into a PCIe interface of a system under test and configured for a PCIe card to plug into a PCIe interface of the PCIe emulation card. The system under test includes a computing device with a processor. The apparatus includes a host connected to the PCIe emulation card. The host includes a data receiver module configured, during a training phase, to receive data from the PCIe emulation card during testing of one or more systems under test using one or more PCIe cards plugged into the PCIe emulation card, and a model builder module configured to build an artificial intelligence (“AI”) model based on the received data. The AI model is configured to emulate a PCIe card through the PCIe emulation card. The apparatus includes a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card. All or a portion of the modules include hardware circuits, a programmable hardware device, and/or executable code stored on non-transitory computer readable storage media.

In some embodiments, the model builder module includes a machine learning module configured to use, during the training phase, machine learning to build the AI model. The machine learning module uses the received data. In other embodiments, the machine learning module uses a decision tree, a K-nearest neighbors routine, a naïve bayes routine, a neural network, ensemble methods, and/or a support vector machine for the machine learning. In other embodiments, the machine learning module processes the received data using a data cleaning routine, a data exploration routine, a sampling routine, an aggregation routine, a discretization routine, feature engineering, feature transformation, feature creation, feature scaling, and/or dimensionality reduction. In other embodiments, the model builder module includes a model evaluator module configured to use the received data and output from the model builder module to retrain the AI model. In other embodiments, the model evaluator module is configured to use an impurity and entropy routine, an error and accuracy routine, a confusion matrix, a precision and recall routine, an F-measure routine, a cost matrix and risk routine, a bias and variance routine, and/or a nested cross validation routine.

In some embodiments, the received data includes signals from the one or more PCIe cards plugged into the PCIe emulation card and signals from the one or more systems under test. In other embodiments, during the training phase, the received data is from the PCIe emulation card while plugged into a plurality of systems under test in combination with a plurality of PCIe cards plugged into the PCIe emulation card. In other embodiments, the PCIe emulation card includes the simulation module and a processor configured to execute the simulation module and the apparatus includes a model transfer module configured to transfer the AI model from the host to the PCIe emulation card.

In some embodiments, prior to the utilization phase, the simulation module is further configured to customize the AI model based on parameters of the system under test during PCIe emulation in the utilization phase. In other embodiments, the simulation module is configured, during the utilization phase, to use a second AI model from a model builder module of a host different from the host connected to the PCIe emulation card. In other embodiments, the model builder module uses a previous version of the AI model along with the received data to create an updated AI model. In other embodiments, the apparatus includes a reevaluation module configured to evaluate, during testing of the AI model, an output of the AI model against a PCIe specification, PCIe standards, and/or PCIe parameters and to signal the model builder module that the output is unacceptable. In response to the signal that the output is unacceptable, the model builder module adjusts the AI model.

A method for simulating an existing PCIe card using a PCIe emulation card includes, during a training phase, receiving data, via a data receiver module on a host, from a PCIe emulation card connected to the host during testing of one or more systems under test using one or more PCIe cards plugged into the PCIe emulation card. The PCIe emulation card is configured to plug into a PCIe interface of a system under test and is configured for a PCIe card to plug into a PCIe interface of the PCIe emulation card. The system under test includes a computing device with a processor. The method includes building, via a model builder module on the host, an AI model based on the received data. The AI model is configured to emulate a PCIe card through the PCIe emulation card. The method includes, during a utilization phase, using, via a simulation module, the AI model to emulate a PCIe card through the PCIe emulation card while the PCIe emulation card is plugged into a system under test and in response to testing of the system under test without a PCIe card plugged into the PCIe interface of the PCIe emulation card.

In some embodiments, the method includes using, during the training phase, machine learning to build the AI model. The machine learning module uses the received data and/or a previous AI model. In other embodiments, the machine learning uses a decision tree, a K-nearest neighbors routine, a naïve bayes routine, a neural network, ensemble methods, and/or a support vector machine for the machine learning. In other embodiments, the machine learning processes the received data using a data cleaning routine, a data exploration routine, a sampling routine, an aggregation routine, a discretization routine, feature engineering, feature transformation, feature creation, feature scaling, and/or dimensionality reduction. In other embodiments, the machine learning uses an impurity and entropy routine, an error and accuracy routine, a confusion matrix, a precision and recall routine, an F-measure routine, a cost matrix and risk routine, a bias and variance routine, and/or a nested cross validation routine.

In some embodiments, during the training phase, the received data is from the PCIe emulation card while plugged into a plurality of systems under test in combination with a plurality of PCIe cards plugged into the PCIe emulation card. In other embodiments, the method includes, prior to the utilization phase, customizing the AI model based on parameters of the system under test during PCIe emulation in the utilization phase. In other embodiments, building the AI model uses a previous version of the AI model along with the received data to create an updated AI model.

An apparatus for simulating an existing PCIe card using a PCIe emulation card includes a PCIe emulation card configured to plug into a PCIe interface of a system under test and configured for a PCIe card to plug into a PCIe interface of the PCIe emulation card. The system under test includes a computing device with a processor. The apparatus includes a host connected to the PCIe emulation card. The host includes a data receiver module configured, during a training phase, to receive data from the PCIe emulation card during testing of a plurality of systems under test in combination with a plurality of PCIe cards plugged into the PCIe emulation card. The received data includes signals from the plurality of PCIe cards plugged into the PCIe emulation card and signals from the plurality of systems under test. The host includes a model builder module configured to build an AI model based on the received data and/or a previous AI model. The AI model is configured to emulate a PCIe card through the PCIe emulation card. The model builder module uses machine learning to build the AI model. The machine learning uses the received data and/or the previous AI model. The apparatus includes a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card. All or a portion of the modules include hardware circuits, a programmable hardware device, and/or executable code stored on non-transitory computer readable storage media.

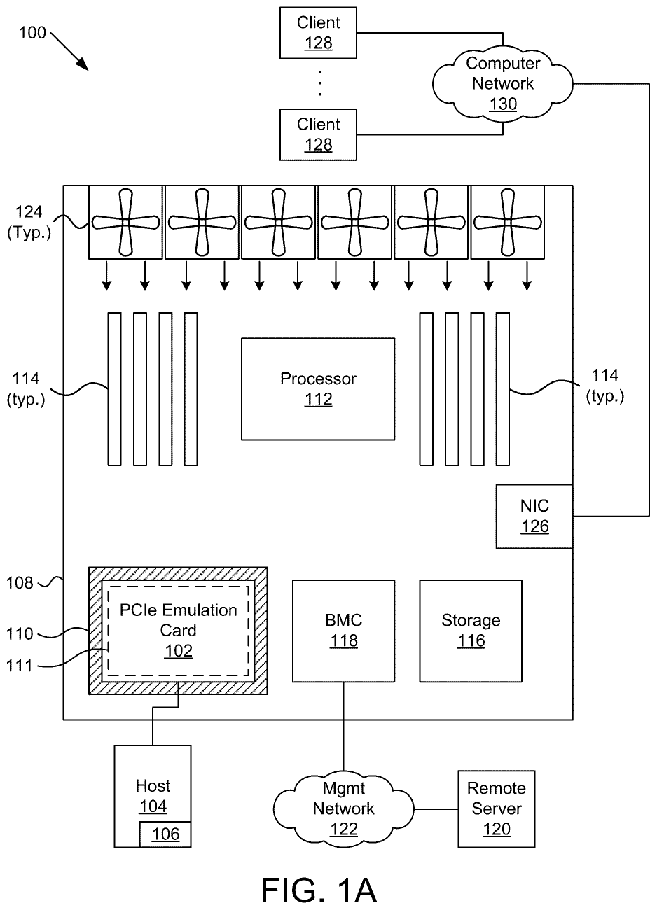

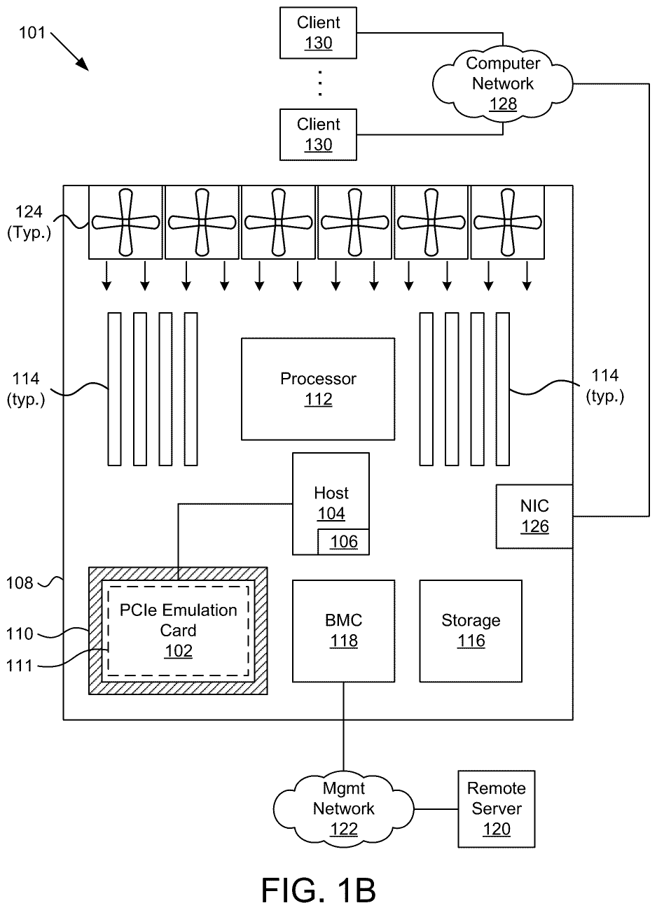

FIG. 1A is a schematic block diagram illustrating a system 100 for simulating an existing PCIe card 111 using a PCIe emulation card 102 connected to an external host 104, according to various embodiments. The system 100 includes the PCIe emulation card 102 inserted in a PCIe interface 110 of a system under test 108 where the PCIe emulation card 102 is connected to a host 104. In some embodiments, the host 104 is connected to the PCIe emulation card 102 via a high speed connection. In other embodiments, the host 104 is connected to the PCIe emulation card 102 via a wiring harness or other hardwired connection. In other embodiments, the host 104 is connected to the PCIe emulation card 102 via a wireless connection. The PCIe interface 110, PCIe emulation card 102, and the PCIe card 111 are depicted in FIG. 1A as rectangles that are wide. In various embodiments, the PCIe interface 110 is configured as a standard PCIe interface that is narrow in a first direction and longer in a second direction and has connectors that match a PCIe standard. In some embodiments, the PCIe interface 110 is adjacent to an edge of the system under test 108 with connectors to connect to the computer network 130, to input/output devices, and other external devices. One of skill in the art will recognize typical PCIe interface configurations, PCIe interface locations, PCIe pin configurations, etc.

The host 104, which in FIG. 1A is external to the system under test 108, includes a PCIe emulation apparatus 106. The PCIe card 111 is depicted as a dashed line on top of the PCIe emulation card 102 and the PCIe emulation card 102 may or may not have a PCIe card 111 plugged into a PCIe interface of the PCIe emulation card 102. The purpose of the PCIe emulation card 102 is to first gather data from one or more PCIe cards 111 inserted into the PCIe emulation card 102 while the system under test 108 is operating and the PCIe cards 111 are functioning. While a PCIe card 111 is plugged into the PCIe emulation card 102, the PCIe emulation card 102 passes signals between the system under test 108 and the PCIe card 111 while sending the signals to the PCIe emulation apparatus 106 on the host 104. The PCIe emulation apparatus 106 uses the signals to build an artificial intelligence (“AI”) model. Once the AI model is built, the PCIe emulation card 102 uses the AI model to simulate a PCIe card when there is no PCIe card attached to the PCIe emulation card 102.

Manufacturers of computing devices typically test computing devices prior to release for deployment or sales to customers. Typically, many of the computing devices are tested at the same time. Often, manufacturers of PCIe cards produce new models, updated models, etc. of the PCIe cards. Often the manufacturers of the PCIe cards initially distribute a small quantity of a new PCIe card, which leaves the manufacturer of a computing device with only one or possibly a small amount of the new PCIe card. The PCIe emulation card 102 and the PCIe emulation apparatus 106 work in tandem to produce an AI model of the new PCIe card or possibly a generic PCIe card where the AI model is then used to simulate the new PCIe card or a generic PCIe card. Thus, once the AI model is created, the AI model may be transferred to many other PCIe emulation cards 102 to simulate the new PCIe card or to emulate a generic PCIe card. In some embodiments, the AI model is transmitted to a test facility at a different location for use with PCIe emulation cards 102 to test computing devices at the different location.

The PCIe emulation apparatus 106 is configured to, during a training phase, receive data from the PCIe emulation card 102 during testing of one or more systems under test 108 using one or more PCIe cards 111 plugged into the PCIe emulation card 102 and to build an AI model based on the received data and/or a previous AI model. The AI model is configured to emulate a PCIe card 111 through the PCIe emulation card 102. In some embodiments, the PCIe emulation apparatus 106 uses machine learning to build the AI model. In some embodiments, the PCIe emulation apparatus 106 is configured to, during a utilization phase, use the AI model to emulate a PCIe card through the PCIe emulation card while the PCIe emulation card is plugged into a system under test 108 and in response to testing of the system under test without a PCIe card 111 plugged into the PCIe interface of the PCIe emulation card 102.

The system under test 108, in some embodiments, is a computing device being tested at a manufacturer or other test location to verify proper operation. The system under test 108 includes a processor 112 and memory, which is depicted in the form of dual inline memory modules 114. In some embodiments, the system under test 108 includes non-volatile data storage 116, which is depicted in the system under test 108. In other embodiments, the system under test 108 has access to non-volatile data storage external to the system under test 108. In some embodiments, the system under test 108 includes a baseboard management controller (“BMC”) connected to a management server 120 over a management network 122. The system under test 108 includes one or more fans 124 blowing air across the components of the system under test 108. In some embodiments, the system under test 108 includes a network interface card (“NIC”) 126 connected to clients 128 over a computer network 130, which may be used during testing of the system under test 108. In some embodiments, the computer network 130 is different than the management network 122. In other embodiments, the BMC 118 is connected through the computer network 130 to the remote server 120 via secure connection, such as a virtual private network (“VPN”) or other secure means. Typically, the remote server 120 is used by a system administrator at the location of the remote server 120 to control the system under test 108. Where the system under test 108 is being tested, the remote server 120 may be at the location where the system under test 108 is being tested.

The BMC 118 is configured to interface with the system under test 108 for control. In some embodiments, the BMC 118 is an XClarity® Controller (“XCC”) by Lenovo®. In other embodiments, the BMC 118 is Management Engine (“ME”) by Intel®. In other embodiments, the BMC 118 is another type by another manufacturer. In general, a BMC in a computing device that is the system under test 108 may be a controller used to monitor and manage the computing device remotely. The BMC 118 may be, for example, used for health monitoring, power management, firmware management, event logging, security, etc.

In some embodiments, the BMCs 118, upon deploying the computing devices in which the BMC 118 is installed, is configured to communicate with a management server (not shown) over the management network 122. In some embodiments, the management server is an XClarity Administrator (“XCA”) by Lenovo. In some embodiments the management server is on-site with the computing devices. In some embodiments, the management server is connected over the management network 122 to an off-site management server, e.g. the remote server 120. In various embodiments, the off-site management server (e.g., 120) is an XCA or an XClarity Orchestrator (“XCO”) by Lenovo.

The host 104 is a computing device that may be remote to the system under test 108. In some embodiments, the host 104 and PCIe emulation card 102 are connected using a high-speed connection to be able to handle the speed and volume of data between the PCIe card 111 and the system under test 108 that is then transmitted from the PCIe emulation card 102.

In various embodiments, the management network 122 and/or the computer network 130 include a LAN, a WAN, a metropolitan area network, a fiber network, a wireless network, and/or the like. The management network 122 and/or the computer network 130 include servers, switches, routers, cabling, and other network equipment. In some embodiments, connection between the PCIe emulation card 102 and the host 104, the management network 122 and/or the computer network 130 include a wireless connection.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ). Alternatively, the wireless connection may be a cellular telephone network communication. All standards and/or connection types include the latest version and revision of the standard and/or connection type as of the filing date of this application.

FIG. 1B is a schematic block diagram illustrating a system 101 for simulating an existing PCIe card 111 using a PCIe emulation card 102 connected to an internal host 104, according to various embodiments. The system 101 of FIG. 1B is substantially similar to the system 100 of FIG. 1A except the host 104 is internal to the system under test 108. While the host 104 is depicted on the system under test 108 for convenience, in some embodiments, the host 104 is located on the PCIe emulation card 102. In some embodiments, only a portion of the host's capabilities are located on the PCIe emulation card 102. In some examples, the PCIe emulation card 102 has computing capabilities to store the AI model and to execute the AI model. In addition, the PCIe emulation card 102, in some embodiments, may be disconnected from an external host 104, such as depicted in FIG. 1A so that the PCIe emulation card 102 is capable of simulating a PCIe card 111 without connection to the external host 104. In other embodiments, the host 104 or capabilities of the host 104 and/or the PCIe emulation apparatus 106 are within or accessible to the BMC 118 and a processor of the BMC 118 executes all or a portion of the PCIe emulation apparatus 106. In some embodiments, the PCIe emulation card 102 is connected wirelessly to an external host 104. One of skill in the art will recognize capabilities of the host 104 and/or the PCIe emulation apparatus 106 that may be implemented on the PCIe emulation card 102 and/or the system under test 108.

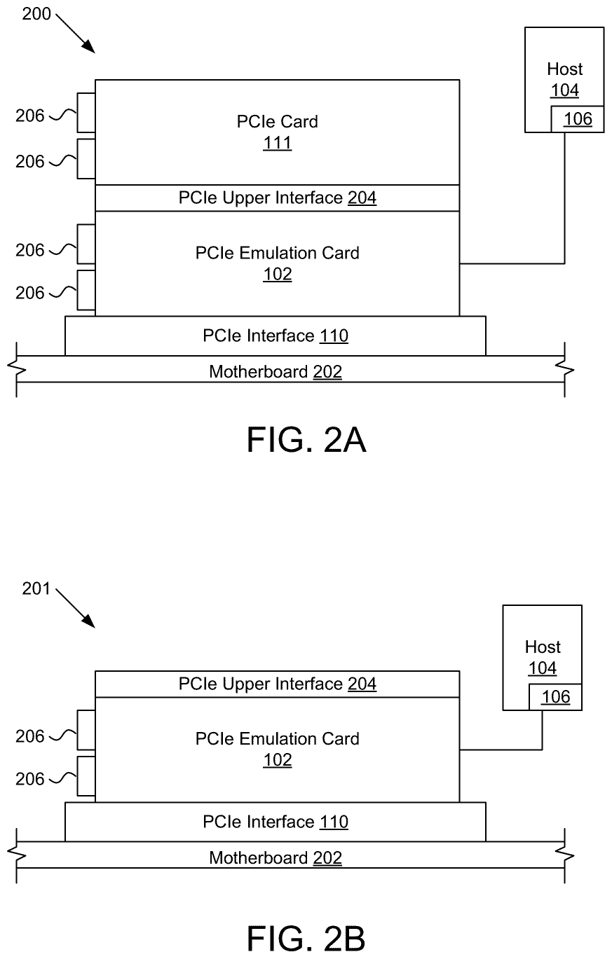

FIG. 2A is a side view schematic block diagram 200 illustrating the PCIe emulation card 102 and a PCIe card 111 for the systems 100, 101 of FIGS. 1A and 1B, according to various embodiments. The PCIe emulation card 102 is plugged into a PCIe interface 110 on a motherboard 202 of the system under test 108. The PCIe emulation card 102 is connected to a host 104 with a PCIe emulation apparatus 106. A PCIe card 111 is plugged into a PCIe upper interface 204 of the PCIe emulation card 102. While the PCIe upper interface 204 is depicted on top of the PCIe emulation card 102, in other embodiments the PCIe upper interface 204 is located elsewhere on the PCIe emulation card 102, such as on a side of the PCIe emulation card 102, or is connected to the PCIe emulation card 102 via a wiring harness or other connection. In the embodiment where the PCIe upper interface 204 is on the side of the PCIe emulation card 102, in some embodiments the PCIe upper interface 204 may be oriented upward away from the motherboard 202 or is oriented horizontally.

In some embodiments, the PCIe emulation card 102 and/or the PCIe card 111 include external ports 206 used to connect to other devices, cables, etc. In some embodiments, one or more of the external ports 206 are configured to connect to a network cable, a universal serial port (“USB”) cable or device, a coaxial cable, or other communication cable or device.

The PCIe card 111 is depicted plugged into the PCIe upper interface 204 in situations where data exchanged between the PCIe card 111 and the motherboard 202 is also sent to the host 104 and PCIe emulation apparatus 106 to be used to build or update an AI model. FIG. 2B is a side view schematic block diagram 201 illustrating use of the PCIe emulation card 102 of FIG. 2A where the PCIe card 111 is detached, according to various embodiments. In such embodiments, the PCIe emulation card 102 includes the AI model and simulates a PCIe card 111. In the embodiments, the PCIe emulation card 102 is configured to communicate with any external devices via the external ports 206 and with the motherboard 202 via the PCIe interface 110 and to simulate the functions of a PCIe card 111. In some embodiments, the host 104 and/or the PCIe emulation apparatus 106 include the AI model and provide and receive signals from the external devices and the motherboard 202. In other embodiments, the host 104 and/or the PCIe emulation apparatus 106 transmit the AI model to the PCIe emulation card 102 and the AI model in the PCIe emulation card is used to emulate the PCIe card 111.

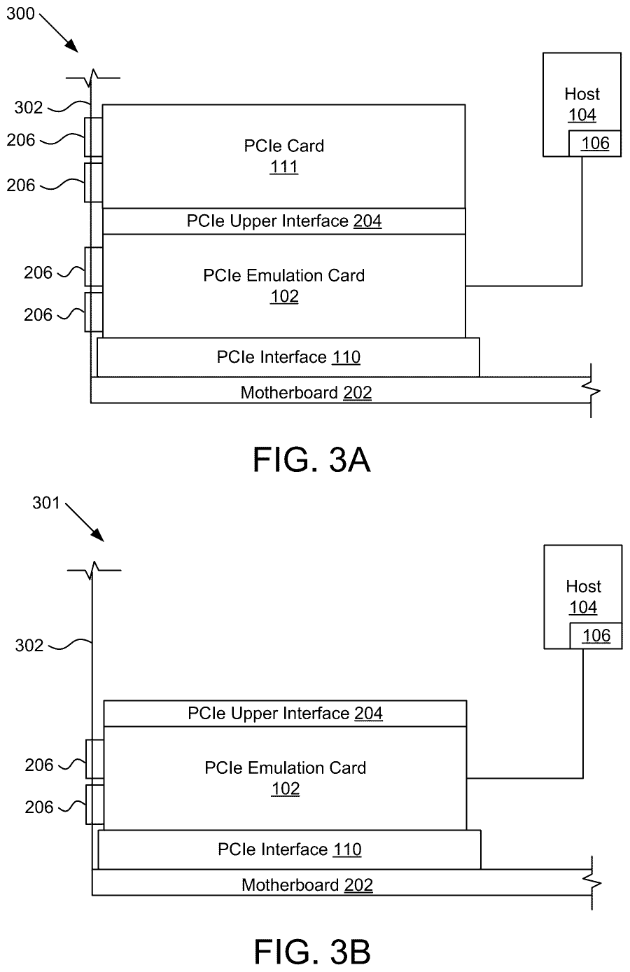

FIG. 3A is a side view schematic block diagram 300 illustrating a PCIe emulation card 102 with external connections and a similar PCIe card 111 with external connections for the system 100 of FIG. 1A, according to various embodiments. The PCIe emulation card 102, the PCIe card 111, host 104, PCIe emulation apparatus 106, and the motherboard 202 of the system under test 108 are substantially similar to those described above in relation to FIGS. 2A and 2B. In the embodiments of FIG. 3A, the PCIe interface 110 is adjacent to a perimeter wall 302 of the system under test 108. In some embodiments, the perimeter wall 302 includes an opening for a metal tab (not shown) wherein the metal tab includes openings for the external ports 206 of the PCIe emulation card 102 and the PCIe card 111. In some embodiments, the metal tab is inserted into an interface at the bottom of the system under test 108 and is secured to the perimeter wall 302 using a fastener, which is similar to other metal tabs for NIC cards, USB ports, etc. In the embodiments of FIG. 3A, the PCIe interface 110 and the PCIe upper interface 204 are configured to allow the PCIe emulation card 102 and the PCIe card 111 to be adjacent to the perimeter wall 302 of the system under test 108.

FIG. 3B is a side view schematic block diagram 301 illustrating use of the PCIe emulation card 102 of FIG. 3A where the PCIe card 111 is detached, according to various embodiments. In the embodiments, the PCIe emulation card 102 is configured to emulate the PCIe card 111 using the AI model while external devices may be connected to the external ports 206.

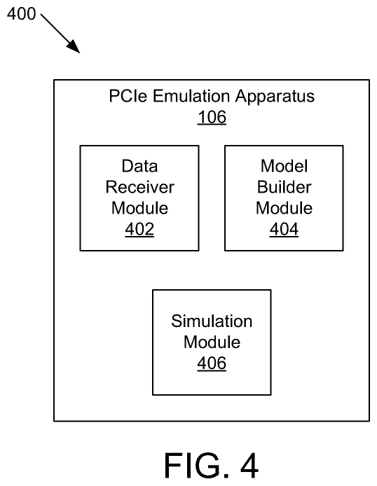

FIG. 4 is a schematic block diagram illustrating an apparatus 400 for simulating an existing PCIe card 111 using a PCIe emulation card 102 connected to the apparatus, according to various embodiments. The apparatus 400 includes a PCIe emulation apparatus 106 with a data receiver module 402, a model builder module 404, and a simulation module 406, which are described below. In some embodiments, the apparatus 400 is implemented using executable code stored on non-transitory computer readable storage media. In other embodiments, all or a portion of the apparatus 400 is implemented using hardware and/or a programmable hardware device.

The apparatus 400 includes a data receiver module 402 configured, during a training phase, to receive data from the PCIe emulation card 102 during testing of one or more systems under test 108 using one or more PCIe cards 111 plugged into the PCIe emulation card 102. In some embodiments, the system under test 108 includes various computing devices, such as a laptop computer, a desktop computer, a workstation, a rack-mounted server, or the like. In other embodiments, one or more PCIe cards 111 are exchanged in the PCIe emulation card 102 to gather data from each of the one or more PCIe cards 111 for each system under test 108.

In some embodiments, the PCIe emulation card 102 has a PCIe card 111 plugged into the PCIe upper interface 204 and the PCIe emulation card 102 is plugged into the PCIe interface 110 during receiving data from the PCIe emulation card 102. In some embodiments while the data receiver module 402 is receiving data, the PCIe emulation card 102 passes signals through from the PCIe card 111 to the system under test 108 and from the system under test 108 to the PCIe card 111 while intercepting the signals and transmitting the signals to the host 104 and the PCIe emulation apparatus 106.

The apparatus 400 includes a model builder module 404 configured to build a AI model based on the received data that was received by the data receiver module 402. The AI model is configured to emulate a PCIe card 111 through the PCIe emulation card 102. In some examples, the AI model is configured to direct the PCIe emulation card 102 to send a particular PCIe signal over a particular pin in the PCIe interface in response to an operation of that would be occurring in the PCIe card, in response to a received signal from an external device over an external port 206, in response to a particular signal from the system under test 108, and/or other conditions that would be present in the PCIe card 111 in similar circumstances. In some embodiments, the AI model is a dataset configured with register values, various states, etc. of a PCIe card 111.

In other examples, the AI model is configured to direct the PCIe emulation card 102 to send a particular device signal to an external device over an external port 206 in response to an operation of that would be occurring in the PCIe card, in response to a received signal from an external device over an external port 206, in response to a particular signal from the system under test 108, and/or other conditions that would be present in the PCIe card 111 in similar circumstances. In some embodiments, the AI model is used to direct the PCIe emulation card 102 to interact with each pin of the PCIe interface 110 and the external ports 206 in the same way as a PCIe card 111.

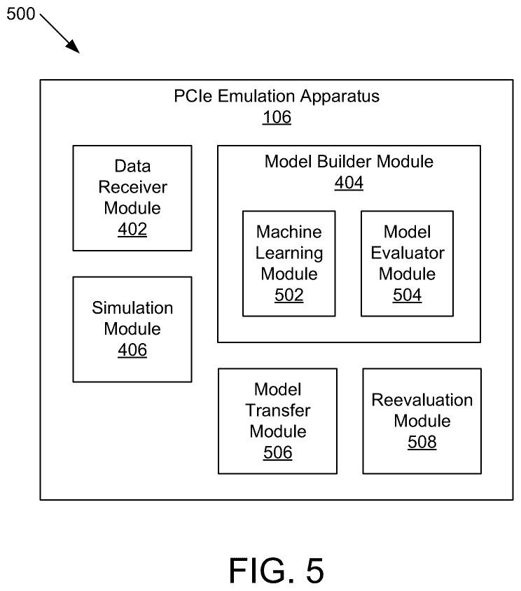

In some embodiments, the data receiver module 402 stores received data from one or more systems under test 108 and one or more PCIe cards 111 and the model builder module 404 builds the AI model from the stored data. In other embodiments, the model builder module 404 uses machine learning and the received data, during a training phase, to build the AI model. The machine learning is described in more detail with respect to the machine learning module 502 of the apparatus 500 of FIG. 5.

The apparatus 400 includes a simulation module 406 configured to, during a utilization phase, use the AI model to emulate a PCIe card 111 through the PCIe emulation card 102 while the PCIe emulation card 102 is plugged into a system under test 108 and in response to testing of the system under test 108 without a PCIe card 111 plugged into the PCIe upper interface 204 in the PCIe emulation card 102. While the apparatus 400 is depicted as including a simulation module 406, in other embodiments the simulation module is located on the PCIe emulation card 102. During the utilization phase, the PCIe card 111 is not present and the PCIe emulation card 102 in conjunction with the AI model is able to emulate a PCIe card 111. In various embodiments, the PCIe emulation card 102 take different forms to emulate different types of PCIe cards 111, such as ethernet PCIe cards, graphics PCIe cards, PCIe cards connected to external devices, and the like.

In some embodiments, the AI model is able to emulate different PCIe cards 111. In other embodiments, the AI model is able to simulate interactions with different systems under test 108, such as desktop computers, laptop computers, workstations, etc. In some embodiments, the host 104 and/or the PCIe emulation card 102 are configured to interact with a user and the user is able to input the PCIe card 111 and/or the system under test 108. In other embodiments, the AI model is able to emulate a generic PCIe card 111 automatically or based on user input. In some embodiments, without user input the AI model is set to emulate the generic PCIe card 111.

FIG. 5 is a schematic block diagram illustrating another apparatus 500 for simulating an existing PCIe card 111 using a PCIe emulation card 102 connected to the apparatus, according to various embodiments. The apparatus 500 includes a PCIe emulation apparatus 106 with a data receiver module 402, a model builder module 404, and a simulation module 406, which are substantially similar to those described above in relation to the apparatus 400 of FIG. 4. In various embodiments, the apparatus 500 includes a machine learning module 502 and/or a model evaluator module 504 in the model builder module 404, a model transfer module 506, and/or a reevaluation module 508, which are described below. In some embodiments, the apparatus 500 is implemented using executable code stored on non-transitory computer readable storage media. In other embodiments, all or a portion of the apparatus 500 is implemented using hardware and/or a programmable hardware device.

In some embodiments, the model builder module 404 of the apparatus 500 includes a machine learning module 502 configured to use, during the training phase, machine learning to build the AI model where the machine learning module 502 uses the received data from the data receiver module 402. In some embodiments, the machine learning module 502 uses a decision tree, a K-nearest neighbors routine, a naïve bayes routine, an artificial neural network, ensemble methods, a support vector machine, and/or a similar routine for the machine learning.

Often an artificial neural network is used by the machine learning module 502. An artificial neural network (“ANN”) is an artificial mathematical model used to approximate nonlinear functions mimicking a neural network of a living being. In some embodiments, the ANN is implemented with a physical machine. In other embodiments, all or a portion of the ANN is implemented using executable code stored on non-transitory computer readable storage media. In some embodiments, the ANN is implemented using neurons arranged into layers with information passing into a first layer. The ANN includes one or more intermediate layers and a final layer that includes outputs. Typically, a signal input into each layer is a number so that input signals are discretized into numbers prior to being input into the input layer. The output of each neuron is also a number. Input into each neuron of the intermediate and final layers, in some embodiments, is a linear combination of the outputs in previous layers. The signal each neuron outputs is calculated from the number into the neuron, according to an activation function. The behavior of the ANN depends on weights of connections between neurons. The ANN, in some embodiments, is trained by modifying the weights through empirical risk minimization or backpropagation to fit a preexisting dataset.

Where an ANN is used by the machine learning module 502, the signals to the input layer are the received data from the data receiver module 402, which are discretized. In some embodiments, the outputs of the final layer are converted to digital or analog signals to be sent to the system under test 108 and/or to the external devices through the external ports 206. Other inputs to the ANN, in some embodiments, include PCIe standards that may limit particular signals, prescribe limits, etc. The activation functions of the intermediate layers and the output layer are configured to train output signals from the output layer based on particular signals of the received data, register values, and the like. Where the machine learning module 502 uses a routine different than the ANN, the received data and output signals from the AI model are adapted for the particular routine used. The end result is an AI model that mimics a particular or generic PCIe card 111.

In some embodiments, the machine learning module 502 is configured to process the received data using a data cleaning routine, a data exploration routine, a sampling routine, an aggregation routine, a discretization routine, feature engineering, feature transformation, feature creation, feature scaling, dimensionality reduction, and/or other similar routine. The above routines are used to prepare the received data for the particular machine learning routine used by the machine learning module 502.

In other embodiments, the model builder module 404 of the apparatus 500 includes a model evaluator module 504 configured to use the received data and output from the model builder module 404 to retrain the AI model. In some embodiments, the model evaluator module 504 compares outputs from the AI model with matching received data. Where there are discrepancies between the outputs from the AI model and the matching received data, the model evaluator module 504 retrains the AI model so that future outputs from the AI model more closely match the corresponding received data. In some embodiments, the model evaluator module 504 is configured to use an impurity and entropy routine, an error and accuracy routine, a confusion matrix, a precision and recall routine, an F-measure routine, a cost matrix and risk routine, a bias and variance routine, a nested cross validation routine, and/or similar routines to evaluate outputs from the model builder module 404 and corresponding received data to retrain the AI model.

In some embodiments, the apparatus 500 includes a model transfer module 506 configured to transfer the AI model from the host 104 to the PCIe emulation card 102. In the embodiments with the model transfer module 506, the PCIe emulation card 102 includes the simulation module 406 and a processor capable of executing the simulation module 406. In some embodiments, the host 104 is disconnectable from the PCIe emulation card 102 and the model transfer module 506 transfers the AI model prior to disconnecting the host 104 from the PCIe emulation card 102.

In some embodiments, the apparatus 500 includes a reevaluation module 508 configured to evaluate, during testing of the AI model, an output of the AI model against a PCIe specification, PCIe standards, and/or PCIe parameters and to signal the model builder module 404 that the output is unacceptable. In response to the signal that the output is unacceptable, the model builder module 404 adjusts the AI model. In some examples, a PCIe specification, PCIe standard, etc. includes a voltage range for a signal, a timing of a signal, or the like and the reevaluation module 508 compares the standard with a corresponding output of the AI model and is configured to determine if the output is compatible with the standard. If not, the reevaluation module 508 notifies the model builder module 404, which adjusts the output of the AI model.

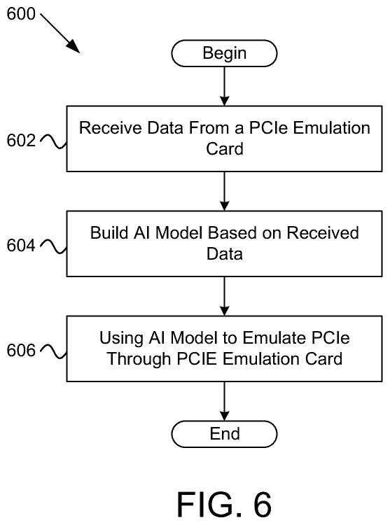

FIG. 6 is a schematic flow chart diagram illustrating a method 600 for simulating an existing PCIe card 111 using a PCIe emulation card 102 connected to a host 104, according to various embodiments. The method 600 begins and receives 602 data during a training phase from a PCIe emulation card 102 connected to the host 104 during testing of one or more systems under test 108 using one or more PCIe cards 111 plugged into the PCIe emulation card 102. The PCIe emulation card 102 is configured to plug into a PCIe interface 110 of a system under test 108 and is configured for a PCIe card 111 to plug into a PCIe interface (e.g., PCIe upper interface 204) on the PCIe emulation card 102. The system under test 108 includes a computing device with a processor 112.

The method 600 builds 604 a AI model based on the received data. The AI model is configured to emulate a PCIe card 111 through the PCIe emulation card 102. The method 600, during a utilization phase, uses 606 the AI model to emulate a PCIe card 111 through the PCIe emulation card 102 while the PCIe emulation card 102 is plugged into a system under test 108 and in response to testing of the system under test 108 without a PCIe card 111 plugged into the PCIe upper interface 204 in the PCIe emulation card 102, and the method 600 ends. In various embodiments, all or a portion of the method 600 is implemented using the data receiver module 402, the model builder module 404, and/or the simulation module 406.

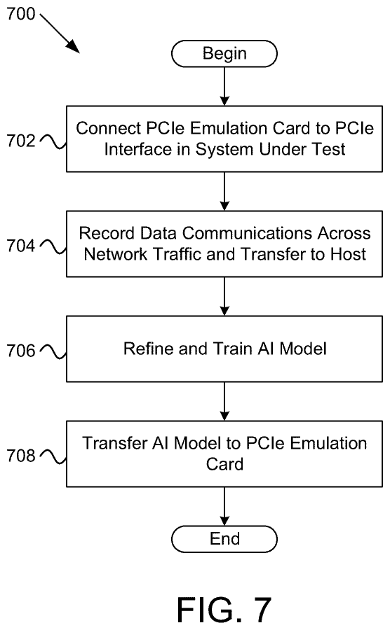

FIG. 7 is a schematic flow chart diagram illustrating a method for building an AI model of PCIe cards 111 using a PCIe emulation card 102 connected to a host 104, according to various embodiments. The method 700 begins and connects 702 a PCIe emulation card 102 into a PCIe interface 110 of a system under test 108 while a PCIe card 111 is plugged into a PCIe upper interface 204 of the PCIe emulation card 102 and records 704 data communications across network traffic between the PCIe card 111 and the system under test 108. The method 700 refines 706 and trains the AI model and transfers 708 the AI model to the PCIe emulation card 102, and the method 700 ends. In various embodiments, all or a portion of the method 700 is implemented using the data receiver module 402, the model builder module 404, the machine learning module 502, the model evaluator module 504, the model transfer module 506, and/or the reevaluation module 508.

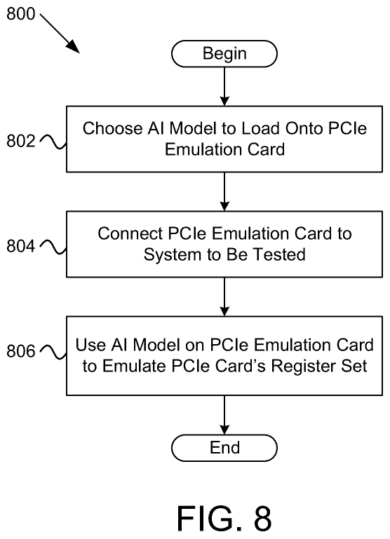

FIG. 8 is a schematic flow chart diagram illustrating a method 800 for using the AI model of FIG. 7 using a PCIe emulation card 102 to simulate a PCIe card 111, according to various embodiments. The method 800 begins and chooses 802 an AI model to load onto the PCIe emulation card 102. In some embodiments, the method 800 chooses 802 an AI model by selecting which PCIe card 111 to emulate and/or the type of system under test 108 where the AI model will be used. The method 800 connects 804 the PCIe emulation card 102 to a system under test 108 and uses 806 the AI model on the PCIe emulation card 102 to emulate the register set of the PCIe card 111, and the method 800 ends. In various embodiments, all or a portion of the method 800 is implemented using the model transfer module 506, and/or the simulation module 406.

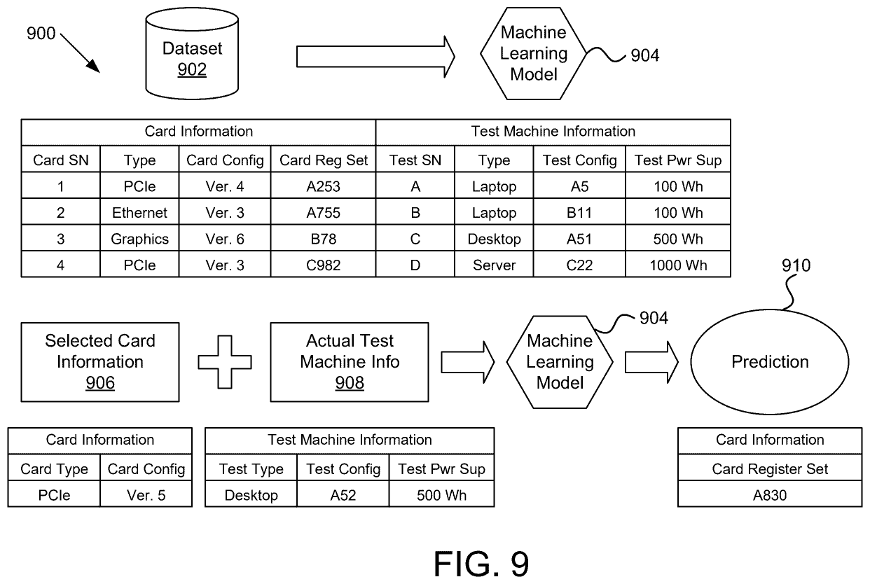

FIG. 9 is a schematic flow chart diagram 900 illustrating building an AI model using different systems and PCIe cards 111 and then selecting a PCIe card 111 to emulate and entering system under test data for the AI model and executing the AI model on a PCIe emulation card 102 to simulate the selected PCIe card 111, according to various embodiments. The top of FIG. 9 illustrates a dataset 902 to be used to derive the AI model, labeled machine learning model. The dataset 902 includes card information, including four different PCIe card types, which are labeled PCIe, ethernet, graphics, and PCIe. Adjacent to the card type information is a card configuration in terms of a version number. Other card type information may be used. The next column includes an identification (“ID”) number of the PCIe card register set. Next to the card information is test machine information, which lists the system under test serial number, a machine type, such as laptop, desktop, or server, the test configuration, and system under test power supply capacity. The card information and the test machine information are used to the model builder module 404 to create the AI model.

The bottom half of FIG. 9 depicts selecting information 906 of a particular PCIe card 111 and information 908 of the actual test machine (system under test 108) to be used to input into the AI model 904 to use to emulate a selected PCIe card 111. The signals output are listed as the prediction 910. The selected information 906 for the PCIe card 111 to be emulated is PCIe version 5 and the information 908 of the system under test 108 is a desktop with test configuration A52 and a power supply capacity of 500 watt hours (“Wh”). The selection of the information 906 of the PCIe card 111 and the information 908 of the system under test 108 results in using card register set A830 to emulate the PCIe card 111.

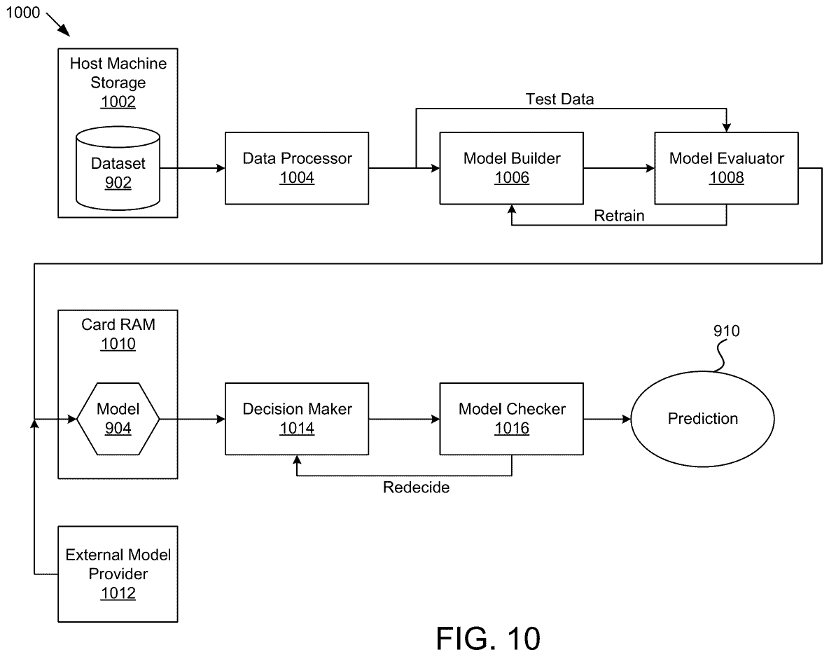

FIG. 10 is a schematic flow chart diagram 1000 illustrating executing an AI model along with additional test data to update the AI model and then using the AI model or an AI model from an external model provider to use the AI model executing on a PCIe emulation card 102 to simulate a PCIe card 111, according to various embodiments. The host machine storage 1002 includes a dataset 902 of the AI model to be executed by the processor 1004 of the host 104. The model builder module 404 includes a model builder 1006 and a model evaluator 1008, which are part of the machine learning module 502 and the model evaluator module 504, respectively. The model builder 1006 creates or updates an AI model based on latest received data from the data receiver module 402 and the model evaluator 1008 evaluates the AI model compared to the test data. Where there are improvements to be made, the model evaluator 1008 retrains the model builder 1006.

In some embodiments, the model builder 1006 uses a decision tree, a K-nearest neighbors routine, a naïve bayes routine, a neural network, ensemble methods, a support vector machine, and/or similar routines for the machine learning. In other embodiments, the model evaluator 1008 uses an impurity and entropy routine, an error and accuracy routine, a confusion matrix, a precision and recall routine, an F-measure routine, a cost matrix and risk routine, a bias and variance routine, and/or similar routines. In some embodiments, the data receiver module 402 processes the received data using a data cleaning routine, a data exploration routine, a sampling routine, an aggregation routine, a discretization routine, feature engineering, feature transformation, feature creation, feature scaling, dimensionality reduction, and/or similar routines.

Where the model evaluator 1008 determines that the AI model is adequate, the AI model 904 is transmitted, for example by the model transfer module 506, to memory, such as card random access memory (“RAM”) 1010 of the PCIe emulation card 102. In other embodiments, an external model provider 1012 provides the AI model 904 to the card RAM 1010 of the PCIe emulation card 102. In some embodiments, a simulation module 406 on the PCIe emulation card 102 includes a decision maker 1014 that uses current data from the system under test 108, PCIe card current register values, etc. to produce a predicted signal, which is evaluated by a model checker 1016 of the simulation module 406. If the model checker 1016 determines that the predicted signal is incorrect, inadequate, etc., the model checker 1016 sends a signal to the decision maker 1014 to redecide. The model checker 1016, in some embodiments, provides information as to why the predicted signal is inadequate. If the model checker 1016 determines that the predicted signal is adequate, the predicted signal is transmitted to the system under test 108, which is depicted in FIG. 10 as a prediction 910.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a peripheral component interconnect express (“PCIe”) emulation card configured to plug into a PCIe interface of a system under test and configured for a PCIe card to plug into a PCIe interface of the PCIe emulation card, the system under test comprising a computing device with a processor;
a data receiver module configured, during a training phase, to receive data from the PCIe emulation card during testing of one or more systems under test using one or more PCIe cards plugged into the PCIe emulation card;
a model builder module configured to build an artificial intelligence (“AI”) model based on the received data, the AI model configured to emulate a PCIe card through the PCIe emulation card; and
a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card,
wherein all or a portion of said modules comprise hardware circuits, a programmable hardware device, and/or executable code stored on non-transitory computer readable storage media.

2. The apparatus of claim 1, wherein the model builder module comprises a machine learning module configured to use, during the training phase, machine learning to build the AI model, the machine learning module using the received data.

3. The apparatus of claim 2, wherein the machine learning module uses a decision tree, a K-nearest neighbors routine, a naïve bayes routine, a neural network, ensemble methods, and/or a support vector machine for the machine learning.

4. The apparatus of claim 2, wherein the machine learning module processes the received data using a data cleaning routine, a data exploration routine, a sampling routine, an aggregation routine, a discretization routine, feature engineering, feature transformation, feature creation, feature scaling, and/or dimensionality reduction.

5. The apparatus of claim 2, wherein the model builder module further comprises a model evaluator module configured to use the received data and output from the model builder module to retrain the AI model.

6. The apparatus of claim 5, wherein the model evaluator module is configured to use an impurity and entropy routine, an error and accuracy routine, a confusion matrix, a precision and recall routine, an F-measure routine, a cost matrix and risk routine, a bias and variance routine, and/or a nested cross validation routine.

7. The apparatus of claim 1, wherein the received data comprises signals from the one or more PCIe cards plugged into the PCIe emulation card and signals from the one or more systems under test.

8. The apparatus of claim 1, wherein during the training phase, the received data is from the PCIe emulation card while plugged into a plurality of systems under test in combination with a plurality of PCIe cards plugged into the PCIe emulation card.

9. The apparatus of claim 1, wherein the PCIe emulation card comprises the simulation module and a processor configured to execute the simulation module and further comprising a model transfer module configured to transfer the AI model from a host to the PCIe emulation card.

10. The apparatus of claim 1, wherein, prior to the utilization phase, the simulation module is further configured to customize the AI model based on parameters of the system under test during PCIe emulation in the utilization phase.

11. The apparatus of claim 1, wherein the simulation module is configured to, during the utilization phase, use a second AI model from a model builder module of a host different from a host connected to the PCIe emulation card.

12. The apparatus of claim 1, wherein the model builder module uses a previous version of the AI model along with the received data to create an updated AI model.

13. The apparatus of claim 1, further comprising a reevaluation module configured to evaluate, during testing of the AI model, an output of the AI model against a PCIe specification, PCIe standards, and/or PCIe parameters and to signal the model builder module that the output is unacceptable, wherein in response to the signal that the output is unacceptable, the model builder module adjusts the AI model.

14. A method comprising:
during a training phase, receiving data, via a data receiver module, from a peripheral component interconnect express (“PCIe”) emulation card connected to a host during testing of one or more systems under test using one or more PCIe cards plugged into the PCIe emulation card, the PCIe emulation card configured to plug into a PCIe interface of a system under test and configured for a PCIe card to plug into a PCIe interface of the PCIe emulation card, the system under test comprising a computing device with a processor;
building, via a model builder module, an AI model based on the received data, the artificial intelligence (“AI”) model configured to emulate a PCIe card through the PCIe emulation card; and
during a utilization phase, using, via a simulation module, the AI model to emulate a PCIe card through the PCIe emulation card while the PCIe emulation card is plugged into a system under test and in response to testing of the system under test without a PCIe card plugged into the PCIe interface of the PCIe emulation card.

15. The method of claim 14, further comprising using, during the training phase, machine learning to build the AI model using the received data and/or a previous AI model.

16. The method of claim 15, wherein the machine learning:
uses a decision tree, a K-nearest neighbors routine, a naïve bayes routine, a neural network, ensemble methods, and/or a support vector machine for the machine learning;
processes the received data using a data cleaning routine, a data exploration routine, a sampling routine, an aggregation routine, a discretization routine, feature engineering, feature transformation, feature creation, feature scaling, and/or dimensionality reduction; and
uses an impurity and entropy routine, an error and accuracy routine, a confusion matrix, a precision and recall routine, an F-measure routine, a cost matrix and risk routine, a bias and variance routine, and/or a nested cross validation routine.

17. The method of claim 14, wherein during the training phase, the received data is from the PCIe emulation card while plugged into a plurality of systems under test in combination with a plurality of PCIe cards plugged into the PCIe emulation card.

18. The method of claim 14, further comprising, prior to the utilization phase, customizing the AI model based on parameters of the system under test during PCIe emulation in the utilization phase.

19. The method of claim 14, wherein building the AI model uses a previous version of the AI model along with the received data to create an updated AI model.

20. An apparatus comprising:
a peripheral component interconnect express (“PCIe”) emulation card configured to plug into a PCIe interface of a system under test and configured for a PCIe card to plug into a PCIe interface of the PCIe emulation card, the system under test comprising a computing device with a processor;
a host connected to the PCIe emulation card, the host comprising:
a data receiver module configured, during a training phase, to receive data from the PCIe emulation card during testing of a plurality of systems under test in combination with a plurality of PCIe cards plugged into the PCIe emulation card, wherein the received data comprises signals from the plurality of PCIe cards plugged into the PCIe emulation card and signals from the plurality of systems under test;
a model builder module configured to build an artificial intelligence (“AI”) model based on the received data and/or a previous AI model, the AI model configured to emulate a PCIe card through the PCIe emulation card, wherein the model builder module uses machine learning to build the AI model, the machine learning using the received data and/or the previous AI model; and
a simulation module configured to, during a utilization phase, use the AI model to emulate a PCIe card through the PCIe emulation card while the PCIe emulation card is plugged into a system under test and in response to testing of the system under test without a PCIe card plugged into the PCIe interface of the PCIe emulation card,
wherein all or a portion of said modules comprise hardware circuits, a programmable hardware device, and/or executable code stored on non-transitory computer readable storage media.
